(19) United States
(12) Patent Application Publication
(10) Pub. No.: US 2013/0294010 A1
(43) Pub. Date: Nov. 7, 2013

(54) MULTILAYER CERAMIC ELECTRONIC COMPONENT AND METHOD OF MANUFACTURING THE SAME

(71) Applicants: Kyoung No Lee, Suwon (KR); Eun Me Park, Suwon (KR); Byung Gyun Kim, Suwon (KR); Chul Soon Ahn, Suwon (KR); Hye Young Choi, Suwon (KR); Young Sook Lee, Suwon (KR)

(72) Inventors: Kyoung No Lee, Suwon (KR); Eun Me Park, Suwon (KR); Byung Gyun Kim, Suwon (KR); Chul Soon Ahn, Suwon (KR); Hye Young Choi, Suwon (KR); Young Sook Lee, Suwon (KR)

(73) Assignee: SAMSUNG ELECTRO-MECHANICS CO., LTD.

(21) Appl. No.: 13/544,724

(22) Filed: Jul. 9, 2012

(30) Foreign Application Priority Data
May 3, 2012 (KR) 10-2012-0046956

(51) Int. Cl. H01G 4/12

(52) U.S. Cl. 361/321.2; 29/25.42

(57) ABSTRACT

There is provided a multilayer ceramic electronic component. The multilayer ceramic electronic component includes: a ceramic body including a dielectric layer; first and second internal electrodes disposed to face each other, having the dielectric layer interposed therebetween in the ceramic body; external electrodes formed on external surfaces of the ceramic body and electrically connected to the first and second internal electrodes; and grooves formed in at least one of top and bottom surface of the ceramic body on which the external electrodes are formed.

### CROSS-REFERENCE TO RELATED APPLICATIONS

This application claims the priority of Korean Patent Application No. 10-2012-0046956 filed on May 3, 2012, in the Korean Intellectual Property Office, the disclosure of which is incorporated herein by reference.

### BACKGROUND OF THE INVENTION

1. Field of the Invention

The present invention relates to a multilayer ceramic electronic component capable of improving bonding force between an external electrode and a ceramic body and coverage of the external electrode.

2. Description of the Related Art

A multilayer ceramic electronic component may be configured to include a plurality of multilayered dielectric layers, internal electrodes disposed to face each other, having the dielectric layer interposed therebetween, and external electrodes electrically connected to the internal electrodes.

The multilayer ceramic electronic component has been widely used as components for computers, PDAs, mobile phones, or the like, due to strengths thereof, such as miniaturization, high capacity, ease of mounting, and the like.

Recently, as electronic products have been miniaturized and multi-functionalized, chip components have also tended to be miniaturized and multi-functionalized. As a result, there is a need to miniaturize multilayer ceramic electronic components and increase the capacity thereof.

Therefore, thinning and stacking of dielectric and the internal electrode layers have been attempted by using various methods. Recently, multilayer ceramic electronic components in which a thickness of a dielectric is thin and a multilayer stacking amount is increased have been manufactured.

In this case, as the multilayer stacking amount is increased, high capacity can be implemented and a thickness of a cover layer is thin.

This degrades bonding force between the external electrode and the ceramic body in the multilayer ceramic electronic component and when bonding force is degraded therebetween, does not serve to prevent the penetration of a plating solution and moisture and thus, may degrade reliability.

3. Related Art Document

Japanese Patent Laid-Open Publication No. 2008-277372

### SUMMARY OF THE INVENTION

An aspect of the present invention provides a multilayer ceramic electronic component having excellent bonding force between an external electrode and a ceramic body.

According to an aspect of the present invention, there is provided a multilayer ceramic electronic component, including: a ceramic body including a dielectric layer; first and second internal electrodes disposed to face each other, having the dielectric layer interposed therebetween in the ceramic body; external electrodes formed on external surfaces of the ceramic body and electrically connected to the first and second internal electrodes; and grooves formed in at least one of top and bottom surfaces of the ceramic body on which the external electrodes are formed.

The grooves may be extendedly formed from one surface of the ceramic body to the other surface thereof, facing the one surface, so as to be formed in a width direction of the ceramic body.

A cross-sectional shape of the grooves in a cross section taken in a width-length direction cut in a thickness direction of the ceramic body may be semicircular.

The grooves may be provided in plural.

The grooves may be formed such that a bottom surface thereof is spaced apart from uppermost and lowermost internal electrodes in the ceramic body by a predetermined interval.

According to another aspect of the present invention, there is provided a method of manufacturing a multilayer ceramic electronic component, including: preparing a ceramic green sheet including a dielectric layer; forming internal electrode patterns on the ceramic green sheet; forming a ceramic laminate by stacking and sintering the green sheets on which the internal electrode patterns are formed; forming grooves on at least one of top and bottom surfaces of the ceramic laminate; forming a ceramic body by cutting the ceramic laminate in which the grooves are formed; and forming external electrodes on external surfaces of the ceramic body so as to cover the grooves.

The grooves may be extendedly formed from one surface of the ceramic body to the other surface thereof, facing the one surface, so as to be formed in a width direction of the ceramic body.

A cross-sectional shape of the grooves in a cross section taken in a width-length direction cut in a thickness direction of the ceramic body may be semicircular.

The forming of the grooves and the cutting of the ceramic laminate may be simultaneously performed.

The grooves may be formed so that the internal electrodes are not exposed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view of line A-A′ of FIG. 1;

FIG. 3 is a top view of a ceramic body according to an embodiment of the present invention;

FIG. 4 is a cross-sectional view of line A-A′ of FIG. 1 according to another embodiment of the present invention;

FIG. 5 is a top view of a ceramic body according to another embodiment of the present invention; and

FIG. 6 is a manufacturing process diagram of a multilayer ceramic capacitor according to another embodiment of the present invention.

### DETAILED DESCRIPTION OF THE EMBODIMENTS

However, embodiments of the present invention may be provided in several other forms and the scope of the present invention is not limited to the following described embodiments. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Hereinafter, a multilayer ceramic electronic component according to an embodiment of the present invention will be described with reference to the accompanying drawings. In particular, the embodiment of the present invention describes a multilayer ceramic capacitor, but is not limited thereto.

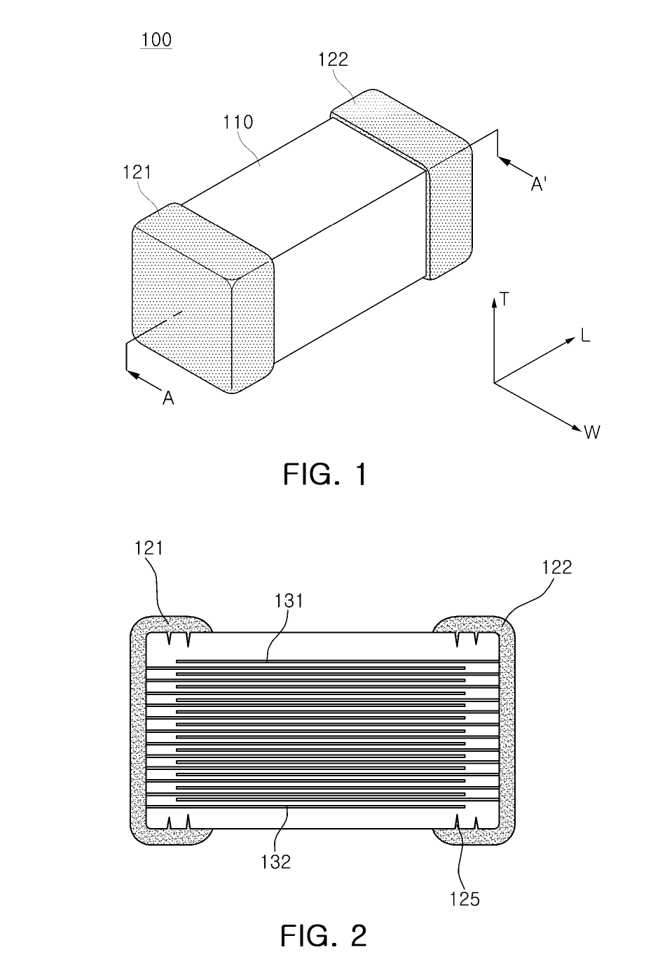

FIG. 1 is a perspective view schematically showing a multilayer ceramic capacitor according to an embodiment of the present invention.

FIG. 2 is a cross-sectional view of line A-A′ of FIG. 1 for describing an embodiment of the present invention.

When defining a hexahedral direction in order to clearly describe embodiments of the present invention, L, W, and T shown in FIG. 1 each represent a length direction, a width direction, and a thickness direction. Here, the thickness direction may be used as the same concept as a direction in which dielectric layers are multilayered.

Referring to FIGS. 1 and 2, the multilayer ceramic capacitor according to the embodiment of the present invention may include a ceramic body and external electrodes.

The ceramic body 110 may be formed by stacking a plurality of dielectric layers in a thickness (T) direction. The plurality of dielectric layers 110 configuring the ceramic body 110 may be integrated such that a boundary between the adjacent dielectric layers may not be readily apparent in a fired state.

Here, the dielectric layer may be formed of high-K ceramic powder. Examples of the high-K ceramic powder may include a barium titanate (BaTiO₃)-based powder, a strontium titanate (SrTiO₃)-based powder, or the like, without being limited thereto.

Various types of ceramic additives, organic solvents, plasticizers, coupling agents, dispersing agents, and the like, may be added to powders such as the barium titanate (BaTiO₃)-based powder, the material forming the dielectric layer.

The inside of the ceramic body 110 may have the first and second internal electrodes 131 and 132 formed therein. The internal electrodes 131 and 132 are formed on a dielectric layer and may be disposed to face each other according to the stacking direction of the dielectric layers, having one dielectric layer interposed therebetween by firing.

The first and second internal electrodes 131 and 132 may be formed of conductive metals, for example, Ni or an Ni alloy. The Ni alloy may contain Mn, Cr, Co, or Al, together with Ni.

The external electrodes 121 and 122 may include a first external electrode 121 and a second external electrode 122 formed on both ends of the ceramic body 110 opposed to one another. As shown in FIG. 1, the first and second external electrodes 121 may be formed to cover external surfaces of both ends of the ceramic body 110.

The first external electrode 121 and the second external electrode 122 may be electrically separated from each other.

The first external electrode 121 may be electrically connected to one end of the first internal electrode 131 exposed to one end surface of the ceramic body 110, and the second external electrode 122 may be electrically connected to one end of the second internal electrode 132 exposed to the other end surface opposing the one end surface of the ceramic body 110 in a length direction. As a result, the external electrodes 121 and 122 may serve as external terminals.

The external electrodes 121 and 122 may be formed of Cu, a Cu alloy, and the like.

As shown in FIG. 2, grooves 125 may be formed in an area in which the external electrodes are formed, in the top surface and the bottom surface of the ceramic body.

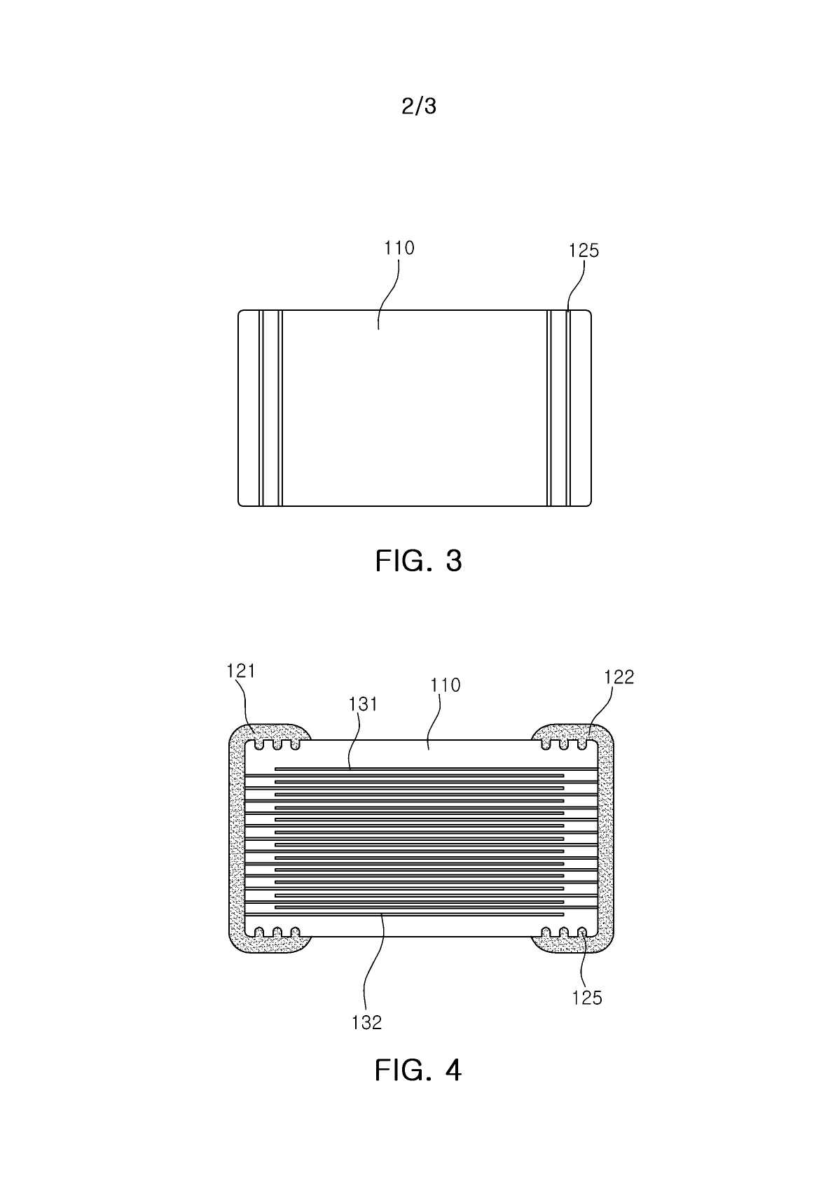

FIG. 3 is a top view of the ceramic body 110 according to the embodiment of the present invention. As shown in FIG. 3, the grooves 125 may be extendedly formed from one surface of the ceramic body 110 to the other surface thereof, facing the one surface, so as to be formed in the width (W) direction of the ceramic body 110.

FIG. 4 is a cross-sectional view in length (L)-thickness (T) directions, in which the multilayer ceramic capacitor according to another embodiment of the present invention is cut in a center thereof, in a width (W) direction.

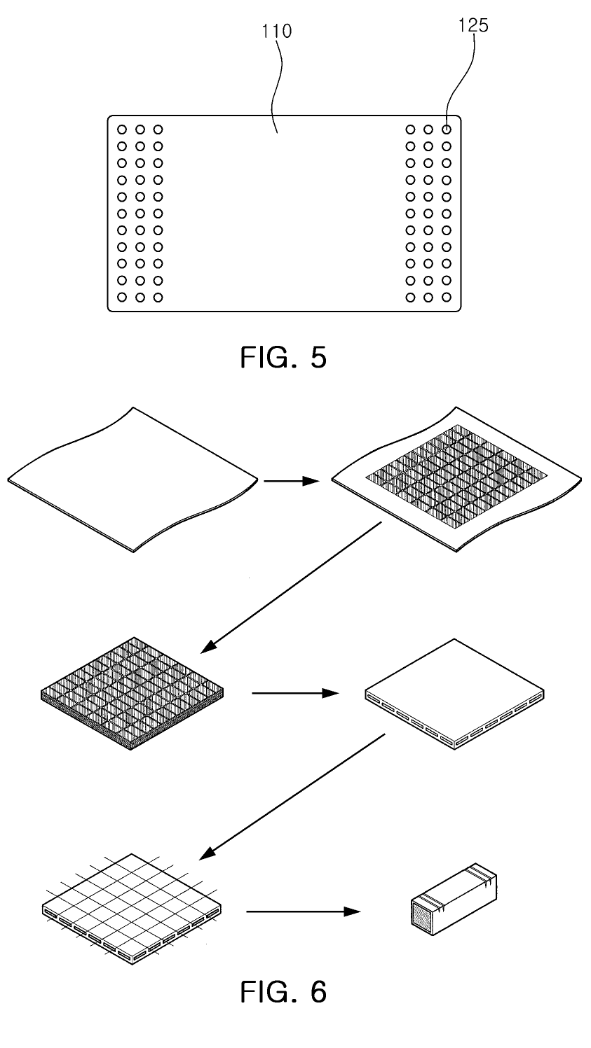

FIG. 5 is a top view of the ceramic body 110 according to another embodiment of the present invention.

Referring to FIGS. 4 and 5, a shape of the grooves 125 taken in a cross section in width (W)-length (L) directions cut in the thickness (T) direction of the ceramic body may be semicircular.

The shape of the grooves 125 is not limited, but a diameter of the semicircle may be formed so as to be smaller toward a center of the ceramic body 110 in the thickness (T) direction thereof.

The grooves 125 maybe formed such that a bottom surface thereof is spaced apart from uppermost and lowermost internal electrodes be in the ceramic body 1110 by a predetermined interval. The predetermined interval is not especially limited and therefore, may be formed so that the internal electrodes are not exposed to the external electrodes by the grooves 125.

A contact area between the ceramic body and the external electrode may be expanded due to the grooves formed in the ceramic body. As the contact area between the ceramic body and the external electrode is expanded, bonding force between the ceramic body and the external electrode may be increased.

The grooves 125 may be provided in plural, and as the number of grooves 125 is increased, the contact area between the ceramic body 110 and the external electrodes 121 and 122 may be expanded.

Therefore, according to the embodiment of the present invention, the multilayer ceramic capacitor having excellent reliability may be implemented by increasing bonding force between the ceramic body and the external electrode and preventing the penetration of plating solution and moisture.

FIG. 6 is a manufacturing process diagram of a multilayer ceramic capacitor for describing another embodiment of the present invention.

Referring to FIG. 6, the manufacturing process may include: preparing a ceramic green sheet including a dielectric layer; forming internal electrode patterns on a ceramic green sheet; forming a ceramic laminate by stacking and sintering green sheets on which the internal electrodes are formed;

forming the grooves in at least one of top and bottom surfaces of the ceramic laminate; forming the ceramic body by cutting the ceramic laminate in which the grooves are formed; and forming the external electrodes on the external surfaces of the ceramic body so as to cover the grooves.

In a method of manufacturing a multilayer ceramic electronic component according to the embodiment of the present invention, the ceramic green sheet including a dielectric layer may be first prepared.

The ceramic green sheet may be manufactured by preparing slurry by mixing a ceramic powder, a binder, and a solvent and then preparing the slurry in a sheet shape having a thickness of several μm by a doctor blade method.

Next, internal electrode patterns may be formed on the ceramic green sheet using a metal paste. The metal paste is not particularly limited and the metal may be at least one selected from a group consisting of nickel (Ni), copper (Cu), palladium (Pd), and a palladium-silver (Pd—Ag) alloy.

The ceramic laminate may be formed by stacking and sintering the green sheet on which the internal electrode patterns are formed.

Next, the grooves may be formed in at least one of the top and the bottom surfaces of the ceramic laminate.

The grooves may be extendedly formed from one surface of the ceramic body to the other surface facing one surface thereof so as to be formed in the width direction of the ceramic body.

When the grooves are formed to have the above-mentioned shape, a process of cutting the ceramic laminate and a process of forming the grooves may be performed simultaneously.

That is, the grooves maybe formed by leaving a cut mark within a range in which the internal electrodes are not exposed to the uppermost and lowermost surfaces of the ceramic laminate with respect to cut surfaces thereof.

When the process of cutting the ceramic laminate and the process of forming the grooves are performed simultaneously, the multilayer ceramic capacitor having the relatively high bonding force between the ceramic body and the external electrode may be manufactured without an additional process.

The grooves may be formed so that the shape of the grooves in a cross section of the width-length direction cut in the thickness direction of the ceramic body is semicircular.

The number of grooves may be provided in plural, and as the number of grooves is increased, the contact area between the ceramic body and the external electrode may be expanded.

The grooves may be formed to be spaced apart from an uppermost internal electrode of the ceramic body by a predetermined interval, having the dielectric layer interposed therebetween, such that the internal electrodes are not exposed to the external electrodes provided in uppermost and lowermost positions of the ceramic body.

The ceramic body is formed by forming the grooves in the ceramic laminate and cutting the ceramic laminate and then, the external electrodes may be formed on the external surfaces of the ceramic body.

The external electrodes may be formed of conductive materials formed of the same material as the internal electrode, but are not limited thereto and may be formed of, for example, copper (Cu), silver (Ag), nickel (Ni), and the like.

The external electrode may be formed by applying a conductive paste prepared by adding glass frit to metal powder and then firing the conductive paste.

The external electrodes may be formed to cover the grooves. The contact area between the ceramic body and the external electrode may be expanded due to the grooves and thus, bonding force between the ceramic body and the external electrode may be increased.

The multilayer ceramic capacitor may be manufactured by a process of forming the external electrode in the ceramic body and a process of plating the formed external electrode.

Therefore, according to the embodiment of the present invention, the multilayer ceramic capacitor having excellent reliability may be implemented by increasing bonding force between the ceramic body and the external electrode and preventing the penetration of moisture and plating solution.

As set forth above, according to the embodiments of the present invention, the multilayer ceramic electronic component may have excellent reliability by improving bonding force between the external electrode and the ceramic body and effectively preventing the penetration of the plating solution and the moisture.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component, comprising:
a ceramic body including a dielectric layer;
first and second internal electrodes disposed to face each other, having the dielectric layer interposed therebetween in the ceramic body;
external electrodes formed on external surfaces of the ceramic body and electrically connected to the first and second internal electrodes; and
grooves formed in at least one of top and bottom surfaces of the ceramic body on which the external electrodes are formed.

2. The multilayer ceramic electronic component of claim 1, wherein the groovess are extendedly formed from one surface of the ceramic body to the other surface thereof, facing the one surface, so as to be formed in a width direction of the ceramic body.

3. The multilayer ceramic electronic component of claim 1, wherein a cross-sectional shape of the grooves in a cross section taken in a width-length direction cut in a thickness direction of the ceramic body is semicircular.

4. The multilayer ceramic electronic component of claim 1, wherein the grooves are provided in plural.

5. The multilayer ceramic electronic component of claim 1, wherein the grooves are formed such that a bottom surface thereof is spaced apart from uppermost and lowermost internal electrodes in the ceramic body by a predetermined interval.

6. A method of manufacturing a multilayer ceramic electronic component, comprising:
preparing a ceramic green sheet including a dielectric layer;
forming internal electrode patterns on the ceramic green sheet;
forming a ceramic laminate by stacking and sintering the green sheets on which the internal electrode patterns are formed;
forming grooves on at least one of top and bottom surfaces of the ceramic laminate;
forming a ceramic body by cutting the ceramic laminate in which the groovess are formed; and
forming external electrodes on external surfaces of the ceramic body so as to cover the grooves.

7. The method of claim 6, wherein the grooves are extendedly formed from one surface of the ceramic body to the other surface thereof, facing the one surface, so as to be formed in a width direction of the ceramic body.

8. The method of claim 6, wherein a cross-sectional shape of the grooves in a cross section taken in a width-length direction cut in a thickness direction of the ceramic body is semicircular.

9. The method of claim 7, wherein the forming of the grooves and the cutting of the ceramic laminate are simultaneously performed.

10. The method of claim 6, wherein the grooves are formed so that the internal electrodes are not exposed.
